(19) United States
(12) Patent Application Publication
(10) Pub. No.: US 2011/0031260 A1
(43) Pub. Date: Feb. 10, 2011

(54) FLOATING BRUSH HOLDER

(76) Inventor: Lynn Bousquet, Racine, WI (US)

Correspondence Address: JANSSON SHUPE & MUNGER LTD., 245 MAIN STREET, RACINE, WI, 53403, US

(21) Appl. No.: 12/537,339

(22) Filed: Aug. 7, 2009

(51) Int. Cl. B44D 3/12

(52) U.S. Cl. 220/736

(57) ABSTRACT

A floatable holder for supporting a plurality of brushes having ferrules in a solvent-containing vessel. The inventive holder includes a buoyant block with front and back surfaces and a top surface therebetween. A series of spaced channels each extends through the block from the front surface to the back surface and has access into the channel through the top surface. The channels are dimensioned to loosely receive the ferrules to allow at least partial submergence of brush bristles with the bristles free of non-fluid contact.

### FIELD OF THE INVENTION

This invention relates to painting equipment and more particularly to devices for suspending paint brushes within a receptacle of solvent out of contact with the bottom of the receptacle while using another brush or during temporary interruptions in the course of painting operations.

### BACKGROUND OF THE INVENTION

An artist will frequently use many brushes and have the need to set a paint brush aside during a painting session. When the brush is laid on a flat surface, the paint dries in the brush and damages it. The brush can also roll around and get paint in undesirable areas.

A brush holder is often used on the table to rest the brush and keep the hairs of the brush off the table and keep the brush from rolling around. One example of devices to hold brushes from rolling is disclosed in U.S. Pat. No. 4,995,515 (Smith). However, the Smith brush rest only supports brushes on a solid surface. This is not desirable for any extended length of time, because of a possibility of damaging the brush hairs by drying paint.

Another option used frequently is to put the brush in a container with a solution such as water or other solvent. Although the solution saves the brush from the drying paint, it is usually undesirable in that the hairs or bristles of the brush can become curled and deformed from resting on the bottom of the container.

Attempts have been made to prevent bristles from contacting the bottom of the container. One such device is disclosed in United States Patent Application Publication No. 2005/0115589 (Perna et al.). This is a flotation device which has a vertical aperture shaped for frictional engagement of a brush handle for vertical suspension of the brush within a liquid. It is designed to be used in cleaning and/or storing manual applicator brushes in which the ferrule is shaped like a shoulder, like those used in house painting. This device has multiple drawbacks in its use during the fine art painting process.

One is that the device can only physically support brushes with a shoulder-like ferrule that is substantially wider than the handle of the brush. The shoulder of a house painting brush would have enough mass at the bottom to keep the brush handle from tipping over. This would not be the case with most common artist brushes which have long thin handles, thin ferrules and small brush heads. An artist brush of this configuration would just tip over in the container when placed in this device.

Another drawback is that it is difficult to position the brush handle within the flotation-device aperture. To insert the brush handle through the bottom of the aperture, the user must pick up the device out of the container of liquid. This would be very inconvenient, messy, and potentially toxic, especially in an application that uses oil paint and solvent. When multiple brushes are used, the removal of the floatation device from the liquid to insert subsequent brushes may be very difficult, time consuming, and result in splashing of the paint and the solvent. Even if it was dimensionally possible, one would not attempt to insert an artist brush through the top of the aperture because that would damage the fine hairs of the brush.

Yet another disadvantage of this device is that not only does it submerge the entirety of the bristles, it also submerges the ferrule and a large part of the handle. This is greatly undesirable, especially with fine art painting brushes. Such submergence and repetitive soaking results in damage to the wooden handle of the brush. It may also result in dissolving the glue inside the ferrule, thus in the loss of brush hairs. All this would clearly ruin the brush.

A variety of other devices have been developed for the purpose of suspending one or more paint brushes at an elevated location within a container. These devices are in general undesirably complex and costly and can pose problems of their own during use. Some such prior devices typically have clips, clamps, coils or other mechanisms for gripping the brush handle that are difficult to operate while one is engaged in the painting process.

One other device used to suspend one or more paint brushes at an elevated location in a container are plastic brush basins. These are plastic tubs with a raised bottom structure in the middle. Such raised bottom structure has a plurality of ramps sloping from the top surface down to each side of the raised bottom structure. The handle of the brush rests on an upper edge of an outer wall of the tub while this raised bottom structure supports the ferrule of a brush with brush hairs in a liquid which is at the bottom of the basin below the raised structure.

This rather bulky device occupies a substantial portion of a stationary workspace and is inconvenient for using while painting outside or transporting for painting in a different location. In addition, there are several other problems with such device. The brush is supported at a substantial angle with respect to horizontal. Because of such an angle, the brush is prone to slide forward with the brush hairs pressed against the opposite wall of the tub which deforms the brush hairs and eventually ruins the brush. Furthermore, there is only a limited amount of liquid that may be poured into the tub to avoid undesirable excessive submergence of the brush. This is because the raised ferrule-supporting structure is at the bottom of the tub. When such liquid is used not only for soaking but also for rinsing the brush during continuous painting, the small amount of the liquid becomes quickly dirty and has to be replaced. This presents a great inconvenience and interruption in an artist's work process.

It is desirable to have a device that allows the brush to rest in water or other solvent to prevent paint from drying on the brush hairs while protecting the brush hairs from deforming and without subjecting the brush handle to harmful soaking.

### OBJECTS OF THE INVENTION

It is an object of the invention to provide an improved brush holder overcoming some of the problems and shortcomings of the prior art, including those referred to above.

Another object of the invention is to provide an improved brush holder that allows the brush to be in the water or other solvent to prevent paint from drying.

Another object of the invention is to provide an improved brush holder that allows the brush to be in a solvent while preventing deformation of the brush hairs.

Still another object of the invention is to provide an improved brush holder that allows the brush to be in a solvent without subjecting the brush handle to harmful soaking.

Yet another object of the invention is to provide an improved brush holder which is portable and lightweight.

Another object of the invention is to provide an improved brush holder which can be used with different containers of various shapes and depths.

How these and other objects are accomplished will become apparent from the following descriptions and the drawings.

### SUMMARY OF THE INVENTION

The present invention is a floatable holder for supporting a plurality of artist brushes having ferrules in a solvent-containing vessel. The inventive holder includes a buoyant block with front and back surfaces and a top surface therebetween. A series of spaced channels, each extending through the block from the front surface to the back surface and has access into the channel through the top surface of the block. The channels are dimensioned to loosely receive the ferrules to allow at least partial submergence of brush bristles with the bristles free of non-fluid contact.

The degree of buoyancy of the floatable brush holder is preferably such that the solvent level is high enough to maintain the wetness of the bristles when the brushes are in substantially horizontal orientation. Therefore, the block is sufficiently buoyant to float at the surface of the solvent, but allows for slight sinking under the weight of the brush ferrule and hairs such that the solvent surface is close enough to the channels at the front surface of the block to maintain the wetness of the brush hairs. In some embodiments, the degree of buoyancy is such that the solvent level is within the channels. However, the solvent does not necessarily need to be within the channels for the inventive bush holder to support the brush with the bristles submerged. The buoyancy of the present invention allows its use in deep containers with a large amount of solvent and in shallow containers while still protecting the brush handle.

The floatable brush holder further preferably includes a substantially horizontal support member spaced from or attached to the block and having an upper support surface at a level above the channel bottoms. The buoyancy of the block and the position and orientation of the support member is preferably selected to support the brushes in an angled orientation with their bristles in contact with the solvent and free of non-fluid contact. Such angle is preferably a minimal angle with respect to horizontal. Such minimal angle is preferably just sufficient to dip the bristles into the solvent and to elevate the brush handle slightly above the solvent level.

In highly preferred embodiments, the block of the floatable brush holder is made of a buoyant material. One example of the buoyant material for making the floating brush holder is a polyethylene foam. However, other suitable buoyant materials may be used. Alternatively, the floatable brush holder may be made of a non-buoyant material filled with air or otherwise achieving buoyancy. Such materials are preferably lightweight to allow for easy transportation and low manufacturing cost.

While in some embodiments the top of the channel may be fully open, it is preferred that the top surface at least partially extend over each channel and leave an opening with a transverse dimension which is smaller than the greatest transverse dimension of the channel. Such over-the-top surface facilitates maintenance of the minimal angle of the brush orientation which helps prevent the wet brush bristles from dipping down and tipping a substantial portion of the brush into the solvent, thus protecting the handle of the brush from the liquid.

The block is made of a resilient material permitting a snap engagement of the brush ferrule in the channel through the top surface. In some embodiments, the top surface may extend over the entirety of the channel with a cut through the top surface to provide access into the channel through the top. In such embodiments, the material of the block is preferably sufficiently flexible and resilient to maintain the block afloat while allowing the brush ferrule to be easily inserted through the cut into the channel.

In some embodiments, a front end of each channel is lower than a back end such that the brush ferrule is supported at an angle submerging the bristles.

It is preferred that the front and rear surfaces of the block define pairs of openings each connected by the corresponding channel which extends through the block. The openings may have a wide variety of shapes which would result in the channels having a wide variety of shapes such as round, square or triangular. The shapes may be selected to accommodate best support for differently-shaped brushes such as with cylindrical or flat ferrules.

In some preferred embodiments, at least one of the channels has a configuration different from another channel to accommodate differently-configured ferrules. Such configurations may vary in shape as well as in size for brushes of different diameter and shape in the same floating brush rest.

The block of the floatable brush holder may have a substantially rectangular shape. The block may also be made of many other shapes such as curved or otherwise supporting a plurality of brushes in angled relationship with respect to each other while maintaining the spirit and benefits of the present invention.

The invention provides a very simple and economical means for suspending one or more paint brushes within a container of liquid when using a different brush to paint with or when painting operations are temporarily interrupted. The brush is held out of contact with the bottom of the container thereby avoiding deformation of the bristle region of the brush. The configuration of the floating device enables an extremely simple mode of engaging and disengaging brushes. It takes little effort to press the brush into the groove of the floating brush support, enabling insertion and extraction of the brush with a minimum of difficulty.

The floatable brush holder may further include an anchoring member connected to the block for its retention in a substantially fixed position in a vessel containing a liquid.

The term “solvent,” as used herein, means any liquid that is used for washing paint off brush bristles. Such liquids may include various chemical solutions for dissolving specific types of paint such as solvents for oil paint. The solvent may also be just water for washing watercolor or other water-soluble paint.

The term “substantially horizontal,” as used herein with respect to the orientation of the brush in the inventive holder, means that the brush is supported only at a slight angle with respect to horizontal such that the brush orientation is closer to horizontal than to vertical.

The invention, together with further aspects and advantages thereof, may be further understood by reference to the following description of the preferred embodiment and by reference to the accompanying drawings.

### BRIEF DESCRIPTION OF THE DRAWINGS

FIG. 1 is a perspective view of a floatable brush holder supporting a brush in a container with a solvent.

FIG. 2 is a perspective view of one embodiment of the floatable brush holder with round openings and substantially cylindrical channels.

FIG. 3 is a front elevation of the floatable brush holder of FIG. 2.

FIG. 4 is a perspective view of another embodiment of the floatable brush holder with substantially rectangular openings and channels.

FIG. 5 is a front elevation of yet another embodiment of the floatable brush holder with substantially triangle openings.

FIG. 6 is a front elevation of still another embodiment of the floatable brush holder with sloping channels.

FIG. 7 is a top elevation of the inventive floatable brush holder.

FIG. 8 is a perspective view of the floatable brush holder of FIG. 1 supporting a brush in a large container with a solvent.

FIG. 9 is a perspective view of the floatable brush holder in a large container with a solvent, the holder including an anchoring member.

FIG. 10 is a perspective view of an embodiment of the floatable brush holder with round openings and substantially cylindrical channels of different diameters.

FIG. 11 is a front elevation of the floatable brush holder of FIG. 10.

FIG. 12 is a perspective view of still another embodiment of the floatable brush holder with openings and channels of different sizes and configurations.

FIG. 13 is a perspective view of another embodiment of the floatable brush holder including an integral support member for elevating the brush handle.

FIG. 14 is a perspective view of yet another embodiment of the floatable brush holder including an integral support member for elevating the brush handle.

### DETAILED DESCRIPTION OF PREFERRED EMBODIMENTS

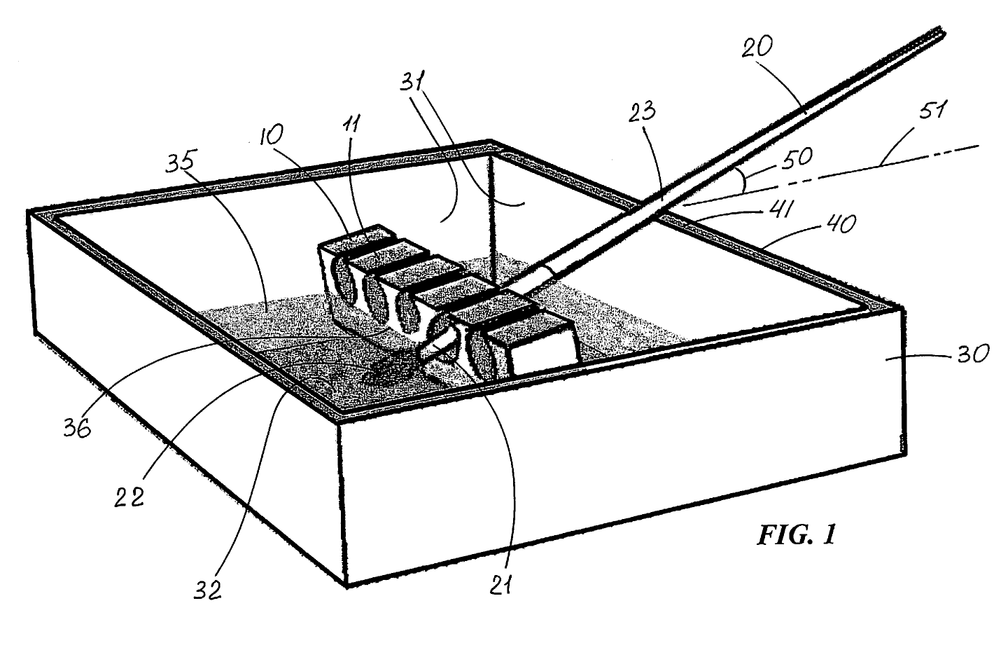

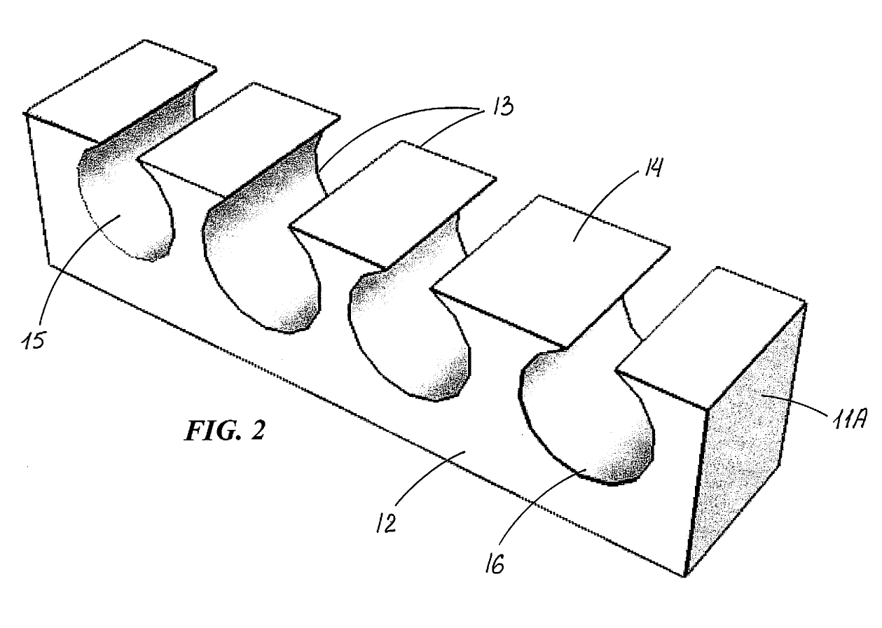

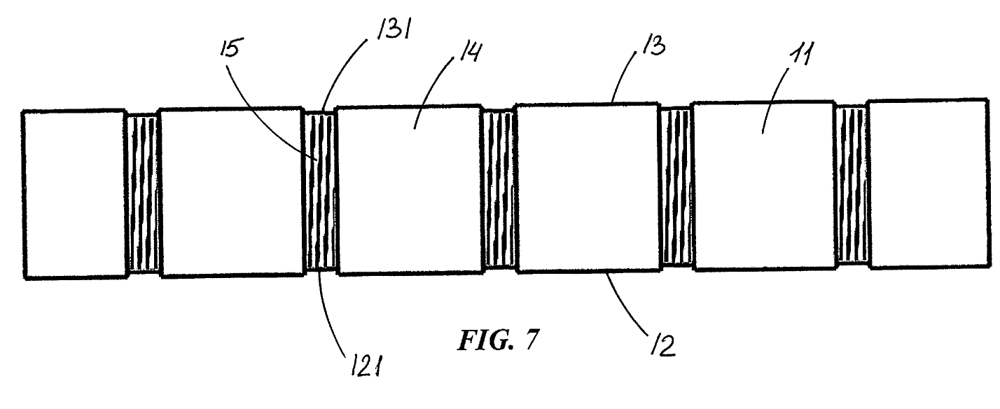

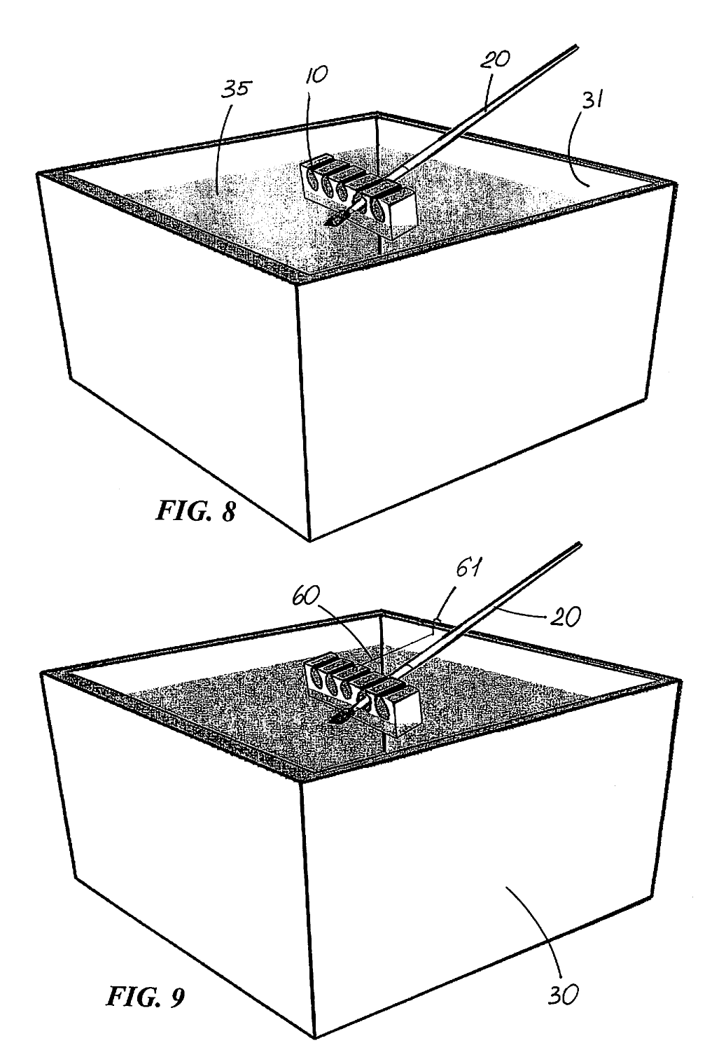

FIGS. 1-14 show a floatable holder 10 for supporting a plurality of brushes 20 having ferrules 21 in a solvent-containing vessel 30. Holder 10 includes a buoyant block 11 with front and back surfaces 12 and 13 and a top surface 14 therebetween. A series of spaced channels 15 each extend through block 11 from front surface 12 to back surface 13 and have access into channels 15 through top surface 14. As best seen in FIGS. 1, 8 and 9, channels 15 are dimensioned to loosely receive ferrules 21 to allow at least partial submergence of brush bristles 22. Bristles 22 are free of non-fluid contact. It is further seen in FIGS. 1, 8 and 9 that brush bristles 22 are suspended in a solvent 35 such that they do not contact any solid surfaces such as vertical walls 31 or a bottom 32 of container 30.

The degree of buoyancy of floatable brush holder 10 is such that solvent level 36 is high enough to maintain the wetness of bristles 22 when brush 20 is in substantially horizontal orientation seen in FIGS. 1, 8 and 9. These FIGURES show that block 11 is sufficiently buoyant to float at a surface 36 surface of a solvent 35, but allows for slight sinking under the weight of brush ferrule 21 and hairs 22 such that solvent surface 36 is close enough to channels 15 at front surface 12 of block 11 to maintain the wetness of brush hairs 22.

Floatable brush holder 10 is used with a substantially horizontal support member 40 spaced from block 11 and having an upper support surface 41 at a level above channel bottoms 16 at front surface 12. The buoyancy of block 11 and the position and orientation of support member 40 supports brushes 20 in an angled orientation with their bristles 22 in contact with solvent 35 and free of non-fluid contact. Such angle 50 is a minimal angle with respect to horizontal 51. Such minimal angle 50 is sufficient to dip bristles 22 into solvent 35 and to elevate brush handle 23 slightly above solvent level 36.

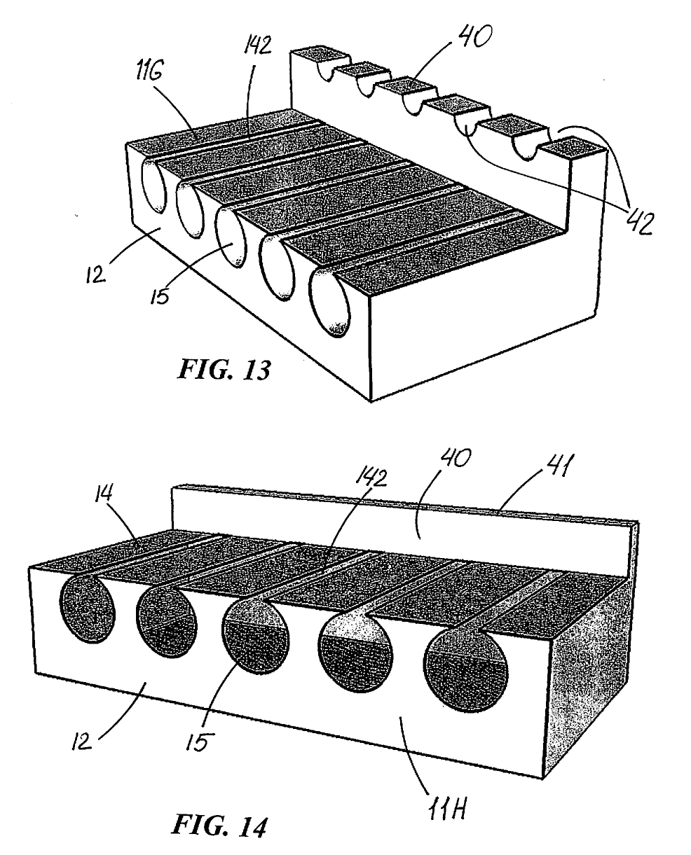

FIG. 1 shows support member 40 as wall 31 of container 30. It should be understood that such support member may be a separate structure that may be set either inside or outside container 30. Such structure 40 may also be securable to wall 31 of container 30. Alternatively, support structure 40 may be connected to block 11 and be either of the same buoyant material or of a different material. FIGS. 13 and 14 show support structure 40 integrally formed with block 11. In FIG. 13, support structure 40G defines a plurality of notches 42 one corresponding to each channel to prevent brush handle 23 from rolling along surface 41.

FIG. 9 further shows that floatable brush holder 10 may also include an anchoring member 60 connected to block 11 for its retention in a substantially fixed position in container 30 with solvent 35. FIG. 9 shows anchoring member as a wire hook 61 extending from block 11 to engage a top edge of wall 31 of container 30.

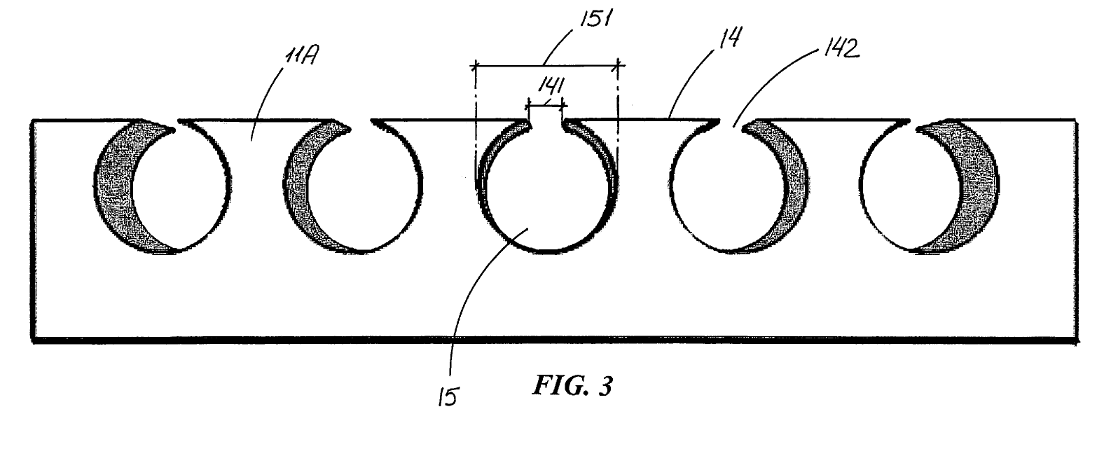

As best seen in FIG. 3, top surface 14 partially extends over each channel 15 and leaves an opening 142 with a transverse dimension 141 which is smaller than greatest transverse dimension 151 of channel 15.

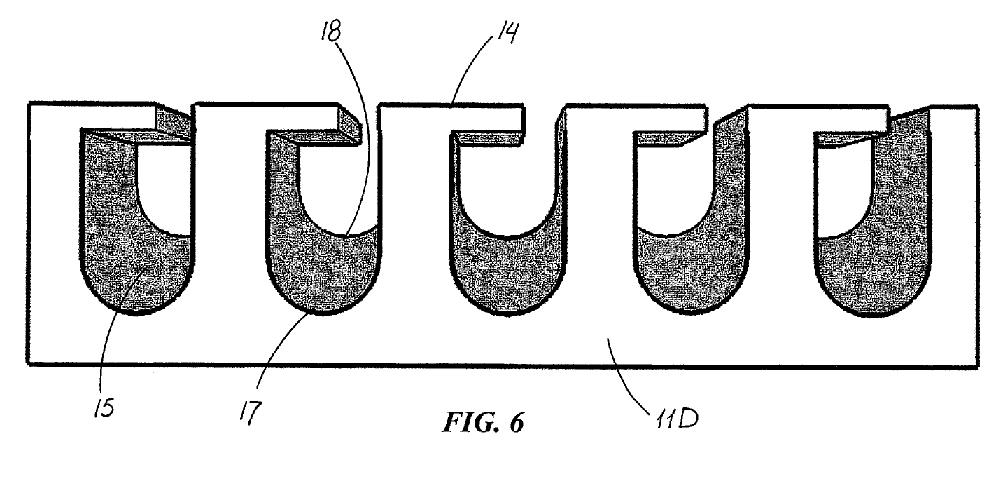

FIG. 6 illustrates block 11D with a front end 17 of each channel 15 being lower than a back end 18 such that brush ferrule 21 is supported at an angle sufficient for submerging bristles 22.

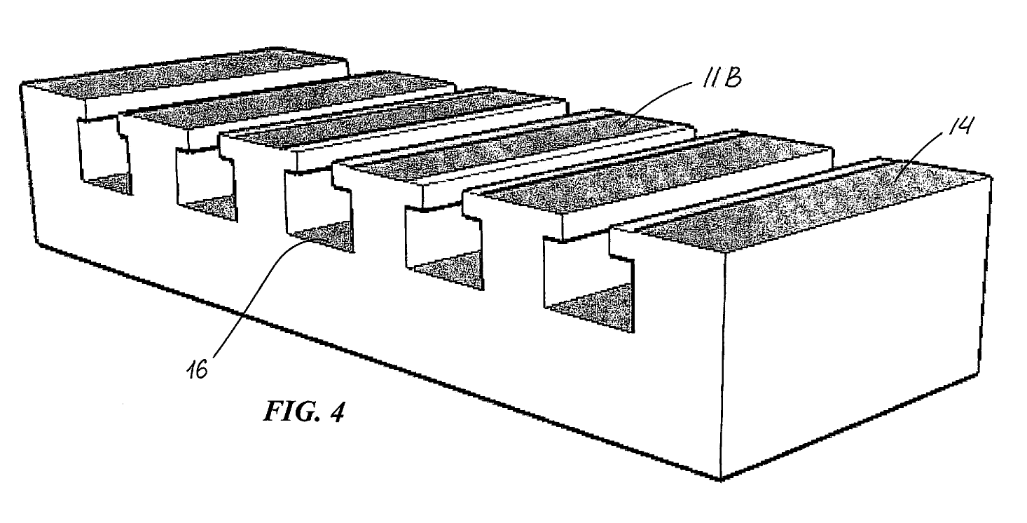

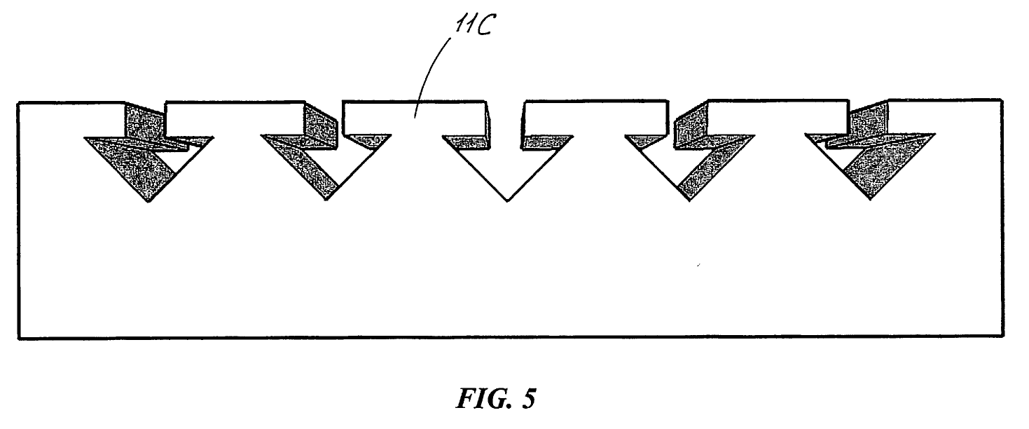

FIG. 7 shows that front and rear surfaces 12 and 13 define pairs of openings 121 and 131 each connected by corresponding channel 15 which extends through block 11. As seen in FIGS. 3-6, openings 121 and 131 may have different shapes which result in channels being of different shapes such as round shown in FIG. 3, square shown in FIG. 4 or triangular shown in FIG. 5. These shapes are selected to accommodate best support for differently-shaped brushes such as with cylindrical or flat ferrules 21.

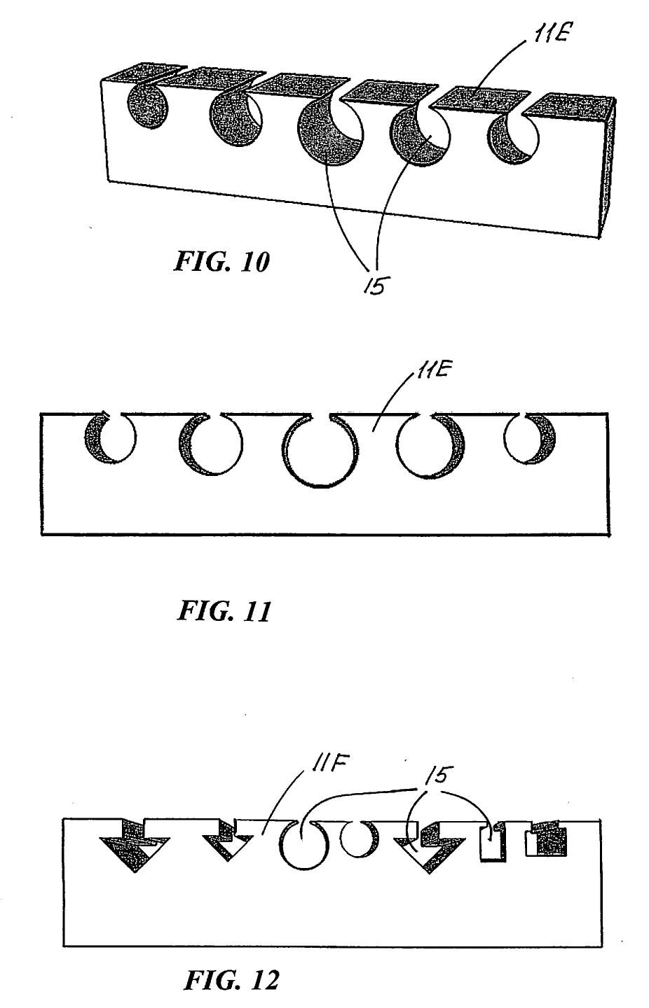

FIGS. 10 and 1 1 show block 11E that has channels 15 of different sizes to accommodate differently-sized brush ferules 21. FIG. 12 illustrates block 11F with channels 15 being of different sizes and different shapes for even greater flexibility in supporting a wide variety of brushes of different types.

FIGS. 1-6 show block 11 of floatable brush holder 10 with a substantially rectangular shape.

While the principles of the invention have been shown and described in connection with specific embodiments, it is to be understood that such embodiments are by way of example and are not limiting.

1. A floatable holder for supporting a plurality of brushes having ferrules in a solvent-containing vessel, the holder comprising a buoyant block with front and back surfaces and a top surface therebetween, a series of spaced channels each extending from the front surface to the back surface and having access through the top surface, the channels dimensioned to loosely receive the ferrules to allow at least partial submergence of brush bristles with the bristles free of non-fluid contact.

2. The floatable brush holder of claim 1 wherein the degree of buoyancy is such that the solvent level is high enough to maintain the wetness of the bristles when the brushes are in substantially horizontal orientation.

3. The floatable brush holder of claim 2 wherein the degree of buoyancy is such that the solvent level is within the channels.

4. The floatable brush holder of claim 2 further including a substantially horizontal support member spaced from the front surface of the block and having an upper support surface at a level above the channel bottoms, the buoyancy of the block and the position and orientation of the support member being selected to support the brushes in an angled orientation with their bristles in contact with the solvent and free of non-fluid contact.

5. The floatable brush holder of claim 1 wherein the top surface at least partially extends over each channel and leaves an opening with a transverse dimension smaller than the greatest transverse dimension of the channel.

6. The floatable brush holder of claim 5 wherein the block is made of a resilient material permitting a snap engagement of the brush ferrule in the channel through the top surface.

7. The floatable brush holder of claim 1 wherein the block is made of a buoyant material.

8. The floatable brush holder of claim 1 wherein a front end of each channel is lower than a back end such that the brush ferrule is supported at an angle submerging the bristles.

9. The floatable brush holder of claim 1 wherein the front and rear surfaces define pairs of openings each connected by the corresponding channel.

10. The floatable brush holder of claim 1 wherein at least one of the channels has a configuration different from another channel accommodating differently-sized ferrules.

11. The floatable brush holder of claim 1 wherein the block has a substantially rectangular shape.
